(19) United States
(12) Patent Application Publication
(10) Pub. No.: US 2003/0161920 A1
(43) Pub. Date: Aug. 28, 2003

(54) Press for separating cocoa mass into cocoa cake and cocoa butter

(76) Inventor: Rob Victor Mantel, Wormer (NL)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/239,612

(22) PCT Filed: Mar. 26, 2001
(86) PCT No.: PCT/NL01/00246

(30) Foreign Application Priority Data
Mar. 24, 2000 (NL) 1014739

(51) Int. Cl. A23P 1/00

(52) U.S. Cl. 426/481

(57) ABSTRACT

The invention relates to a press for separating cocoa mass into cocoa cake and cocoa butter, comprising a frame, in which a plurality of pressure elements are disposed, and means for compressing the pressure elements, wherein the pressure elements each comprise a cavity (9) for receiving cocoa mass to be pressed, in which cavity at least one squeezer is present, and wherein a filter (10, 10′) is disposed in front of the squeezer and on the side of the cavity opposite said squeezer. In the filling position of the squeezer, the spacing between the said filters (10, 10′) is in a range from 40 to 90 mm. This enables a substantial increase in the production capacity of the press.

The present invention relates to a press for separating cocoa mass into cocoa cake and cocoa butter, comprising a frame, in which a plurality of pressure elements are disposed, and means for compressing the pressure elements, wherein the pressure elements each comprise a cavity for receiving cocoa mass to be pressed, in which cavity at least one squeezer is present, and wherein a filter is disposed in front of the squeezer and on the side of the cavity opposite said squeezer.

A press of this kind is known from e.g. International patent application WO 92/12853. Such presses are used for separating cocoa mass into cocoa butter (which is liquid at an elevated temperature) on the one hand and solid cakes, which can be processed into cocoa powder, on the other hand. Generally, a hydraulic cylinder is provided, which is formed in a cylinder block which is connected with a retainer by means of two separate tie rods. Present in the cylinder is a plunger, and between said plunger and the retainer there is disposed a series of pressure elements. The pressure elements comprise a so-called pot, which defines a (usually cylindrical) cavity in which a squeezer and for example two filters are present. The space between the filters is intended for receiving an amount of cocoa mass to be pressed.

During a pressure cycle the pots are filled with heated cocoa mass via supply lines, and subsequently they are compressed. The cocoa butter is thereby pressed out through the filters and discharged.

In many cases the cocoa industry requires that the obtained cakes contain less than 10% by weight of cocoa butter. In order to meet this requirement with a hydraulic press according to the prior art, prolonged pressing at a very high pressure is necessary.

The object of the present invention is to provide a press which makes it possible to reduce the length of a pressure cycle significantly and/or to reduce the pressure, all this preferably without drastic modification of the press in comparison with the prior art presses.

In order to accomplish that objective, the press according to the invention is characterised in that, in the filling position of the squeezer, the spacing between the said filters is in a range from 40 to 90 mm. It is preferred that the said spacing is in a range from 60 to 90 mm, preferably in a range from 60 to 76 mm.

Surprisingly it has become apparent that the production capacity of the present press can be increased significantly in this manner, as will be discussed in more detail hereafter.

The invention furthermore relates to a method for operating a press wherein the position of the squeezer is selected such that, during the step of filling the cavity with cocoa mass, the spacing between the said filters is in a range from 40 to 90 mm.

This method makes it possible to (partially) utilise the advantages of the present invention in existing presses. Furthermore, it is possible to modify the pressure elements of existing presses such that, in the filling position of the squeezer, the spacing between the said filters is in a range from 40 to 90 mm.

For the sake of completeness, it is noted that German patent application 1109501 discloses a press comprising a single pot, which should have a filling height of about 20 mm and which should not exceed 30 mm.

The invention will now be explained in more detail with reference to the drawings, which show an exemplary embodiment of a hydraulic press according to the invention.

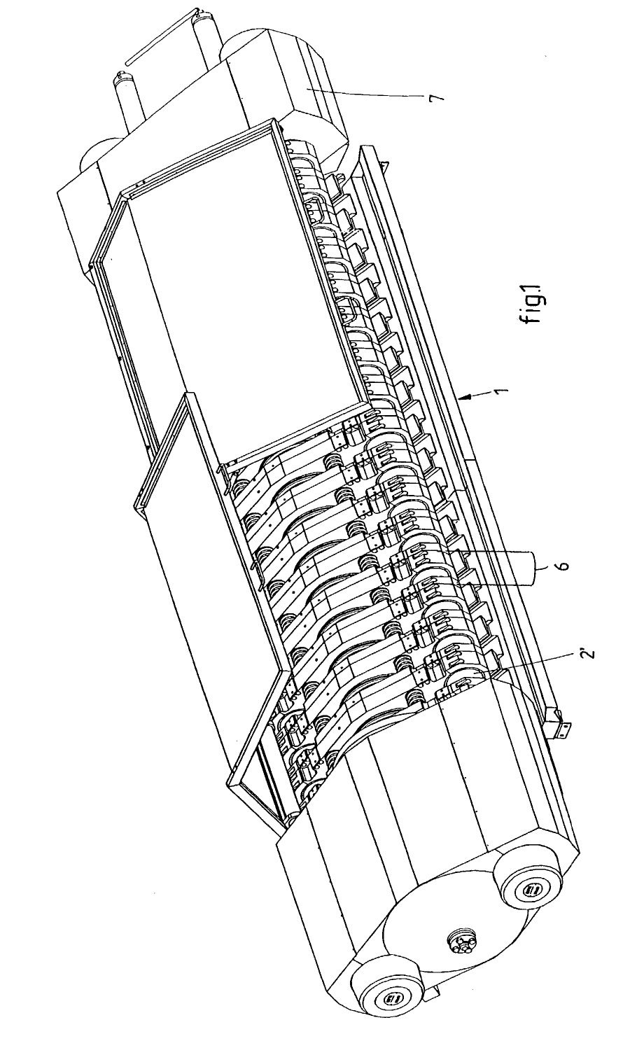

FIG. 1 is a perspective view of a hydraulic press according to the invention for pressing cocoa mass.

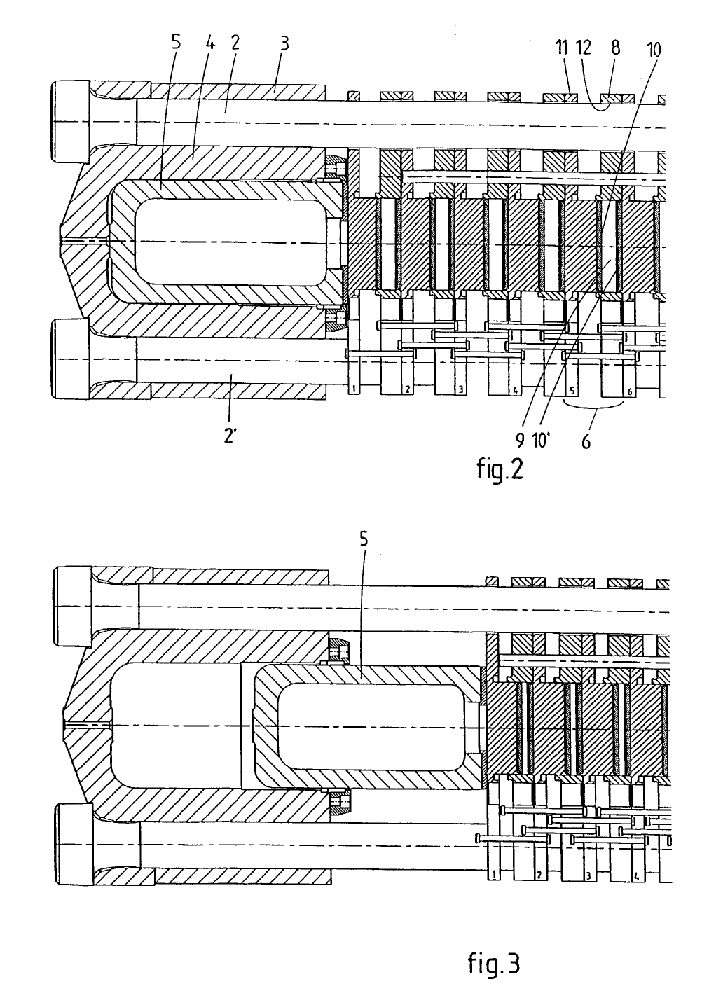

FIG. 2 is a cross-sectional view of the press of FIG. 1 in the filling position.

FIG. 3 is a sectional view corresponding to FIG. 2, showing the end of the pressure phase.

The drawings show a hydraulic press according to the invention which is adapted for pressing cocoa mass, wherein cocoa cakes to be processed into cocoa powder and cocoa butter pressed from said cocoa mass are formed. This pressing process and the pressure elements and pressure means associated therewith are known per se and will be discussed only briefly.

The hydraulic press 1 as shown is mounted in a frame (not shown) and includes two tie rods 2, 2′, which are secured in a cylinder jacket 3 of a hydraulic pressure cylinder 4, on the left-hand side of press 1 in the drawing. Present in pressure cylinder 4 is a plunger 5, which is capable of reciprocating movement therein. Plunger 5 is capable of exerting a pressure on a series of sixteen (in this embodiment) pressure elements 6, which are supported by a retainer 7 at the end remote from plunger 5. Retainer 7 and cylinder jacket 3 are connected by tie rods 2, 2′.

As is shown in FIGS. 2 and 3, pressure elements 6 each comprise a pot 8 including a circular cylindrical cavity 9 which is bounded at head faces by disc-shaped filters 10, 10′ that have a diameter of 450 mm and that are known per se. The left-hand filter 10 is supported by a so-called press-plate which abuts a cylindrical squeezer 11, which fits the cylindrical cavity 9 precisely. The right-hand filter 10′ is also supported by a press-plate which abuts the back of a squeezer which forms part of the pressure element that is disposed to the right of pot 8. The pots as well as the squeezers are mounted round tie rods 2, 2′ by means of circular holes 12, which are formed in the side portions of the pots and the squeezers. The pots furthermore include supply lines for the cocoa mass, whilst the press-plates and the squeezers include discharge lines for discharging cocoa butter that has been pressed through the filters.

FIG. 2 shows the press 1 in the filling position. In this position the hydraulic plunger 5 occupies its extreme left-hand position, and the spacing between the disc-shaped filters 10, 10′, and thus the volume of cavity 9 in each of the pressure elements 6, is maximal. According to the invention, all points or nearly all points of cavity 9 must be spaced from an imaginary plane through the filter or through one of the filters by a distance of less than 45 mm. For cavity 9, which is provided with two flat parallel filters 10, 10′ at both ends, this means that the spacing between said filters 10, 10′ must not exceed 90 mm. In this exemplary embodiment the optimal spacing between the filters 10, 10′ that are present in each of the pressure elements 6 was found to be 71 mm in the filling position. In a further embodiment (not shown) of the invention, the press comprised a series of eighteen pressure elements, the cavities were also circular cylindrical and had a diameter of 600 mm. In this particular embodiment, the optimal spacing was found to be 67 mm.

FIG. 3 shows how the pressure elements 6 of the press according to FIG. 1 are compressed evenly by moving plunger 5 to the right until the pressure reaches a specific threshold value and the spacing between the filters has been reduced to for example 36 mm. In this position the larger part of the cocoa butter present in the cocoa mass has been pressed through filters 10, 10′. Plunger 5 can be moved to the left again, after which the obtained cocoa cakes can be removed from cavities 9.

As already mentioned before, in many cases the cocoa industry requires that the obtained cakes contain less than 10% cocoa butter. In order to accomplish this, a spacing of more than 92 mm between the two filters in the filling position is selected in the hydraulic presses according to the prior art. Typical pressure cycles last 20 to 25 minutes (min.) and require a pressure of 550 bar. For a prior art press comprising fourteen pots this means that 200-250 kg (220 kg, for example) cocoa mass is processed per cycle.

Surprisingly it has become apparent that the duration of the pressure cycle in some cases can be reduced by 5 to 10 minutes with the press according to the invention as described above, whilst the required pressure can be reduced by about 10%. A press according to the invention which comprises sixteen pots is capable of processing as much cocoa mass per pressure cycle as a prior art press of the same length which comprises fourteen pots. Because the cycle can be carried out is (much) less time, however, the production capacity of the press according to the invention is about 25-50% higher.

In addition, it has become apparent that the composition of the obtained cakes is more homogeneous; the content of cocoa butter in the cake ranges from 9.5-10.5% versus 9-13% in the cakes obtained with a prior art press. As a result, the former cakes belong to a higher quality class and their economic value is higher.

A significant advantage from a viewpoint of process technique is furthermore the fact that the risk of so-called “opening” of the press is smaller. In some cases, some pressure elements remain stationary during the pressing operation, whilst others on the other hand are forced aside, as a result of which one or more pots can open and considerable damage to the press may result. This phenomenon is less likely to occur in the press according to the invention, which may be connected with the enhanced homogeneity of the cakes.

Stresses in the frame will be lower due to the lower pressure in the pressure cylinder, as a result of which a more inexpensive material, in particular steel, can be used and no refining methods, or less special ones, for the material are required. This makes it possible to use a cheaper frame construction.

From the foregoing it will be apparent that the invention offers significant advantages over prior art presses whilst the measures to be taken are relatively simple. The invention may be used on existing presses either by adapting the control or operation of the press, in particular by opening the cavities in the pressure elements less far during filling, or by modifying the press and providing it with (more) narrower pressure elements, in particular pots, squeezers, and press-plates.

The invention is not limited to the embodiment as described above, which can be varied in several ways without departing from the scope of the claims, of course. Thus the press can also be used for products whose pressing and filtration behaviour is comparable to that of cocoa mass. Furthermore, it is possible to use a spacing of more than 45 mm between some points in the cavity and a filter, for example as a result of the presence of a partition for attaching a filter or as a result of the shape of the squeezer or of the cavity wall. This variety as regards the spacing will not stand in the way of an adequate operation of the press according to the invention.

1. A press (1) for separating cocoa mass into cocoa cake and cocoa butter, comprising a frame, in which a plurality of pressure elements (6) are disposed, and means (4, 5) for compressing the pressure elements (6), wherein the pressure elements (6) each comprise a cavity (9) for receiving cocoa mass to be pressed, in which cavity (9) at least one squeezer (11) is present, and wherein a filter (10, 10′) is disposed in front of the squeezer (11) and on the side of the cavity (9) opposite said squeezer (11), characterized in that, in the filling position of the squeezer (11), the spacing between the said filters (10, 10′) is in a range from 40 to 90 mm.

2. A press (1) according to claim 1, wherein said spacing is in a range from 60 to 90 mm, preferably in a range from 60 to 76 mm.

3. A press (1) according to claim 1 or 2, wherein said cavity (9) is cylindrical and wherein the filters (10, 10′) are flat or substantially flat.

4. A method for operating a press (1) in accordance with the preamble of claim 1, characterized in that the spacing between the said filters (10, 10′) is in a range from 40 to 90 mm, during the step of filling the cavity (9) with cocoa mass.

5. A method for modifying a press (1) in accordance with the preamble of claim 1, characterized in that the pressure elements (6) are modified so that, in the filling position of the squeezer (11), the spacing between the said filters (10, 10′) is in a range from 40 to 90 mm.

6. A method according to claim 5, wherein in addition the number of pressure elements (6) is increased.

7. A method according to any one of the claims 4-6, wherein said spacing is in a range from 60 to 90 mm, preferably in a range from 60 to 76 mm.

8. A method according to any one of the claims 4-7, wherein said cavity (9) is cylindrical and wherein the filters (10, 10′) are flat or substantially flat.
